(19) United States
(12) Patent Application Publication
(10) Pub. No.: US 2010/0124503 A1
(43) Pub. Date: May 20, 2010

(54) Method for producing a turbine blade holder for an internal flow rate determination device

(76) Inventors: Roman Beyer, Berlin (DE); Uwe Dunkel, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/616,162

(22) Filed: Nov. 11, 2009

(30) Foreign Application Priority Data
Nov. 14, 2008 (EP) 08019938.3

(51) Int. Cl. F01D 5/00; B23P 15/00

(52) U.S. Cl. 416/204 R; 29/889

(57) ABSTRACT

A method for producing a turbine blade holder for an internal flow rate determination device is provided. A base body of the turbine blade holder with an influx channel formed in the base bode and a three-dimensional model of a turbine blade with a recess including the negative geometry of a sealing element to be produced, are made. The three-dimensional model is placed on the base body and the sealing element is applied on the base body in a cavity delimited by the contour of the recess and the base body around the influx channel In another aspect, a turbine blade holder produced by the method is provided.

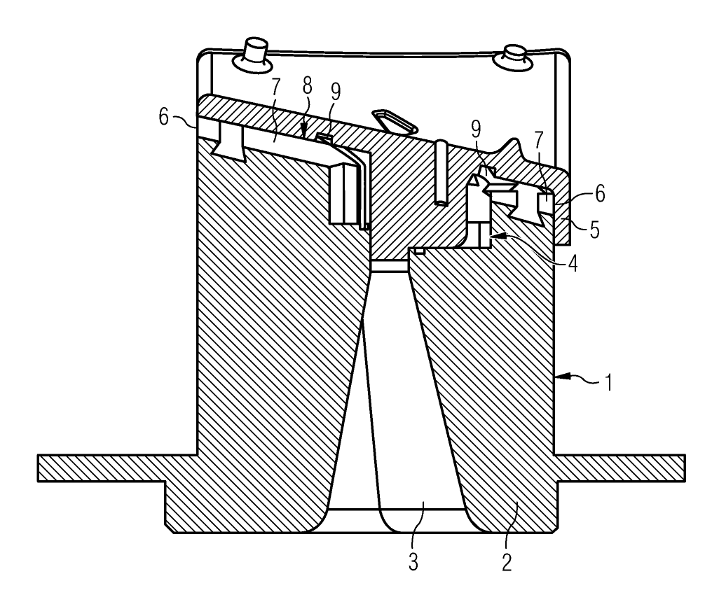

### CROSS REFERENCE TO RELATED APPLICATIONS

This application claims priority of European Patent Office application No. 08019938.3 EP filed Nov. 14, 2008, which is incorporated by reference herein in its entirety.

### FIELD OF INVENTION

The invention relates to a method for producing a turbine blade holder for an internal flow rate determination device, and to a turbine blade holder which can be produced by the method.

### BACKGROUND OF INVENTION

Turbine blades are exposed to high temperatures in a chemically aggressive atmosphere during operation, which can lead to them being damaged. It is therefore necessary to protect the blades by cooling. To this end cooling air channels, which communicate with cooling air bores through the outer wall of the turbine blade, are formed inside the turbine blades. During operation, cooling air is blown through openings of the cooling air channels in the blade root, and flows through the channels to the cooling air bores and out of the latter. The outflowing cooling air reduces the temperature of the turbine blade.

In newly produced or repaired turbine blades, it is necessary to check whether the cooling air channels and bores can ensure sufficient cooling of the turbine blade during operation. For this reason, the flow rate of cooling air through the turbine blade is determined.

In the prior art, through flow rate determination devices are known which can be used for carrying out such an inspection method. These devices comprise a holder, in which the turbine blade to be checked is fixed with its blade root. An influx channel is formed in the holder, through which air can be blown into the openings of the cooling channels in the blade root. A device is furthermore provided which collects all of the air flowing out of the cooling air bores and sends it to a measuring device. With the aid of the measuring device, the flow rate of air through the turbine blade can then be determined.

In the known devices, the problem of sufficient sealing arises between the holder and the turbine blade fixed in it. It is furthermore necessary to ensure that the turbine blade is secured axially and radially against rotation or tilting. Lastly, it is necessary to take into account technical flow features of the individual turbine blades.

In order to meet these requirements, a seal, on which the turbine blade bears with its surface in the fixed state, is provided around the influx channel in the known holder. It is however difficult to produce such a seal which is adapted sufficiently to the complex geometry of the blade root of the turbine blade respectively to be checked.

In order to produce the holder, a turbine root has previously being positioned on a metal base body. A flexible sealing body with the negative geometry of the blade root is then cast from a two-component resin around the blade root on the base body with a form and force fit. In order to make this possible, it is necessary to prepare the turbine blade in advance. For instance, parts of the blade must be machined away or cut away, openings must be closed, casting inserts must be fitted and seals must be applied.

Despite the high outlay associated with this, it has not been possible to produce a seal which satisfies the stringent requirements in relation to sealing performance and the supporting and positioning function.

### SUMMARY OF INVENTION

It is therefore an object of the invention to provide a method for producing a turbine blade holder for an internal flow rate determination device, with the aid of which it is possible to obtain a turbine blade holder that satisfies all the sealing, positioning and supporting requirements.

This object is achieved according to the invention by making a base body of the turbine blade holder with an influx channel formed in it and a three-dimensional model of a turbine blade, with a recess which has the negative geometry of a sealing element to be produced, placing the three-dimensional model on the base body and applying the sealing element on the base body in a cavity delimited by the contour of the recess and the base body around the influx channel.

According to the invention, a base body of the holder, in which an influx channel for air or another testing fluid is formed, is thus produced. A three-dimensional model of the turbine blade to be checked with the aid of the device is furthermore made, which comprises a recess with the negative geometry of the sealing element to be produced. The model is placed on the base body, the contour of the recess and the base body delimiting a cavity around the influx channel in which the sealing element is placed on the base body.

The basic concept of the invention is to use a three-dimensional model of the turbine blade in order to produce the turbine blade holder, instead of the turbine blade itself. This is advantageous particularly in that the negative geometry of the sealing element is already integrated in the model. This makes it readily possible to apply a sealing body, which respectively corresponds exactly to the spatial requirements of the turbine blade to be examined, on the base body. For this reason, the sealing element also satisfies all the sealing, positioning and supporting requirements. The expensive procurement of turbine blades from mass production is furthermore obviated. Lastly, the model can easily be produced as often as required at low cost.

In a refinement of the invention, a CAD model is used for making the three-dimensional model, in particular an STL model of the turbine blade, to which the recess is added. The three-dimensional model is then made on the basis of the CAD model thus modified. The conventional CAD model usually already developed during the design of turbine blades can be used here, in order to make a three-dimensional model with the aid of it after appropriate modification, for example the addition of the recess. A particular advantage with this is that modifications to the three-dimensional model, or the sealing element to be produced with the aid of it, can be performed rapidly and simply by adapting the CAD model.

The three-dimensional model of the turbine blade may be made by stereolithography, laser sintering and/or by oriol machining. In particular when a modified CAD model of the turbine blade is used, the three-dimensional model can thus be made rapidly, in an automated fashion and with high precision.

According to another embodiment, the sealing element may be cast on the base body. In this case, the cavity delimited by the contour of the recess and the base body acts as a mold for the casting material.

Advantageously, a silicone sealing element may be applied on the base body. A sealing element made of this material exhibits a particularly strong sealing effect.

It is likewise possible for the recess to be formed at least locally by the negative shape of a sealing lip. A sealing element with a sealing lip can be obtained with the aid of a three-dimensional model which comprises such a recess. The sealing lip projects from the sealing element and thus produces a high specific application pressure on the sealing surface, when the turbine blade is fixed in the holder.

According to a refinement of the invention, the recess is formed locally by the negative shape of supporting and/or positioning elements. In this way, it is possible to produce a turbine blade holder in which the turbine blade is secured axially and radially against rotation or tilting.

The invention also relates to a turbine blade holder of an internal flow rate determination device, which can be produced by the method according to the invention.

### BRIEF DESCRIPTION OF THE DRAWINGS

The invention will be explained in detail below with the aid of an exemplary embodiment with reference to the drawing.

The single FIGURE of the drawing shows in section a turbine blade holder 1 according to the invention during production.

### DETAILED DESCRIPTION OF INVENTION

The turbine blade holder 1 comprises a base body 2, in particular made of metal or a metal alloy, with an influx channel 3 formed in it and a reception region 4 for a blade root of the turbine blade to be fixed.

A three-dimensional model 5 of the turbine blade to be fixed, which comprises a recess 6 with the negative geometry of a sealing element to be produced, is placed on the base body 2. The recess 6 in this case locally has the negative shape of a sealing lip.

The contour of the recess 6 and the base body 2 delimits a cavity 7 around the influx channel 3. In the cavity 7, a silicone sealing element 8 is cast with a form and force fit on the base body 2. The sealing element 8 fills the cavity 7. This means that the cavity determines the shape of the sealing element 8. In the transition region with the three-dimensional model 5, the sealing element 8 is therefore provided with a circumferential sealing lip 9 projecting in the direction of the three-dimensional model 5.

In order to produce the turbine blade holder 1, the base body 2 is first produced with the aid of methods known in the prior art, for example by using a CNC machine. The three-dimensional model 5 is then made. In particular a (virtual) CAD model of the turbine blade, already available from the design process, may be used as the starting point. The recess 6 is added to this CAD model. Finally, the three-dimensional model 5 is made in a manner known per se, for example by stereolithography, on the basis of the CAD model thus modified.

The three-dimensional model 5 is placed on the base body 2. Silicone is subsequently introduced into the cavity 7 until it is entirely filled. The silicone then forms the sealing element 8 in the cavity 7.

After the sealing element 8 has thus been cast on the base body 2, the three-dimensional model 5 may be removed from the base body 2. The base body 2, with the sealing element 8 applied on it, forms the turbine blade holder 1.

The turbine blade to be fixed may be put into the turbine blade holder 1 with its root region. The turbine blade then lies on the sealing element 8. Particularly in the region of the sealing lip 9, a very high application pressure is obtained so that a strong sealing effect is ensured.

When the turbine blade holder 1 is used for through flow rate determination, no air escapes between the turbine blade and the turbine blade holder 1.

1-8. (canceled)

9. A method for producing a turbine blade holder for an internal flow rate determination device, comprising:
producing a base body of the turbine blade holder with an influx channel formed in the base body;
creating a three-dimensional model of a turbine blade, with a recess which includes a negative geometry of a sealing element to be produced;
placing the three-dimensional model on the base body; and
applying a sealing element on the base body in a cavity delimited by a contour of the recess and the base body around the influx channel.

10. The method as claimed in claim 9,
wherein a CAD model is used for making the three-dimensional model,
wherein the recess is added to the CAD model, and
wherein the three-dimensional model is created using the modified CAD model.

11. The method as claimed in claim 10, wherein the three-dimensional model is an STL model of the turbine blade.

12. The method as claimed in claim 9, wherein the three-dimensional model of the turbine blade is made using stereolithography, laser sintering and/or by oriol machining

13. The method as claimed in claim 9, wherein the sealing element is cast on the base body.

14. The method as claimed in claim 9, wherein a silicone sealing element is applied on the base body.

15. The method as claimed in claim 9, wherein the recess is formed by a negative shape of a sealing lip.

16. The method as claimed in claim 9, wherein the recess is faulted by the negative shape of a plurality of supporting and/or positioning elements.

17. The method as claimed in claim 9, wherein the base body is made of a metal or a metal alloy.

18. A turbine blade holder of an internal flow rate determination device, comprising:
a base body with an influx channel formed in the base body.

19. A turbine blade holder of an internal flow rate determination device, where the turbine blade holder is produced using a method, comprising:
producing a base body of the turbine blade holder with an influx channel formed in the base body;
creating a three-dimensional model of a turbine blade, with a recess which includes a negative geometry of a sealing element to be produced;
placing the three-dimensional model on the base body; and
applying a sealing element on the base body in a cavity delimited by a contour of the recess and the base body around the influx channel.

20. The turbine blade holder as claimed in claim 19,
wherein a CAD model is used for making the three-dimensional model,
wherein the recess is added to the CAD model, and
wherein the three-dimensional model is created using the modified CAD model.

21. The turbine blade holder as claimed in claim 20, wherein the three-dimensional model is an STL model of the turbine blade.

22. The turbine blade holder as claimed in claim 19, wherein the three-dimensional model of the turbine blade is made using stereolithography, laser sintering and/or by oriol machining.

23. The turbine blade holder as claimed in claim 19, wherein the sealing element is cast on the base body.

24. The turbine blade holder as claimed in claim 19, wherein a silicone sealing element is applied on the base body.

25. The turbine blade holder as claimed in claim 19, wherein the recess is formed by a negative shape of a sealing lip (9).

26. The turbine blade holder as claimed in claim 19, wherein the recess is formed by the negative shape of supporting and/or positioning elements.

27. The turbine blade holder as claimed in claim 19, wherein the base body is made of a metal or a metal alloy.
